(19) United States
(12) Patent Application Publication
(10) Pub. No.: US 2013/0305155 A1
(43) Pub. Date: Nov. 14, 2013

(54) AUDIO CONTROL DEVICE USING MULTI-SCREEN AND CONTROL METHOD THEREOF

(71) Applicant: Keejung Yoon, Gyeonggi-do (KR)

(72) Inventor: Keejung Yoon, Gyeonggi-do (KR)

(21) Appl. No.: 13/997,605

(22) PCT Filed: Nov. 29, 2011
(86) PCT No.: PCT/KR2011/009153

§ 371 Date: Jun. 24, 2013

(30) Foreign Application Priority Data
Dec. 24, 2010 (KR) 10-2010-0134632

(51) Int. Cl. G06F 3/16

(52) U.S. Cl. CPC G06F 3/165
USPC 715/716

(57) ABSTRACT

The present invention relates to an audio control device using a multi-screen. The audio control device has a touch screen on which a bass axis and a treble axis for the sound of audio equipment are displayed in a multidimensional fashion, and on which a point selected by a user for audio control is inputted. An audio control section collectively calculates a bass value and a treble value corresponding to the point selected for audio control. A control section controls a speaker based on a result calculated by the audio control section.

### TECHNICAL FIELD

The present invention relates to an audio control method using a multi-screen which can collectively control the sound of audio equipment, surround speakers or radio and compact disc (CD) channels by displaying control values thereon on a multi-screen.

### BACKGROUND ART

Recently, audio equipment mounted in vehicles or the like is provided with a digital liquid crystal display (LCD) screen. In particular, as the number of vehicles equipped with a navigator or a large screen is increasing, it is possible to control the audio equipment using the navigator or a large screen.

Specifically, an example of a related-art method of controlling audio equipment involves individually controlling the bass, treble or the like in order to control the volume of the audio equipment or individually controlling the volume of speakers which are disposed in the front, rear, left and right sides of a vehicle depending on the positions such as front, rear, left and right.

In the foregoing related-art method of controlling audio equipment, an object to be adjusted is displayed in one-dimensional fashion, such that one operation is carried out for one object. This requires a user to manipulate the audio equipment several times in order to properly control it, thereby becoming inconvenient, which is problematic.

### DISCLOSURE

### Technical Problem

The present invention has been made to solve the foregoing problems with the related art, and therefore the present invention is intended to provide an audio control device using a multi-screen and a control method thereof which can improve user convenience by collectively conducting audio control in a multidimensional fashion.

### Technical Solution

According to an aspect of the present invention for overcoming the foregoing problems, provided is an audio control device using a multi-screen that includes: a touch screen on which a bass axis and a treble axis for the sound of audio equipment are displayed in a multidimensional fashion, and on which a point selected by a user for audio control is inputted; an audio control section which collectively calculates a bass value and a treble value corresponding to the point selected for audio control; and a control section which controls speakers based on the result calculated by the audio control section.

Preferably, also provided is an audio control device using a multi-screen that includes a touch screen on which X and Y-axes are displayed in a multidimensional fashion, and a point selected by a user for the volume control over surround speakers which are provided at different positions is inputted; a surround control section which collectively calculates volume values of the surround speakers depending on the positions that correspond to the point selected for volume control over the surround speakers; and a control section which controls the surround speakers based on the result calculated by the surround control section.

Preferably, also provided is an audio control device using a multi-screen that includes a touch screen which displays an image of a radio channel, radio frequencies of the radio channel, a compact disc (CD) channel and tracks of the CD channel in a multidimensional fashion, and on which a point selected by a user for channel adjustment is inputted; a channel adjustment section which calculates the radio frequencies of the radio channel or the tracks of the CD channel corresponding to the point selected for channel adjustment; and a control section which collectively controls the execution on the radio frequencies of the radio channel or the tracks of the CD channel based on the result calculated by the channel adjustment section.

Preferably, the touch screen may further have a volume axis, and the audio control section collectively calculates, together with the bass value and the treble value, a volume value based on the result.

Preferably, the channel adjustment section may store a specific radio frequency or a name of a specific broadcasting system to a radio frequency button.

Preferably, the audio control device may further include a button input into which the point selected by the user is inputted.

Preferably, the audio control device may further include a voice input into which the point selected by the user is inputted by a voice.

Preferably, the audio control device may further include a voice recognition section which analyzes the voice that is inputted via the voice input.

Preferably, the audio control device may further include a storage which stores a control value for a multidimensional axis corresponding to the selected point.

Preferably, the audio control device may further include a voice output which outputs a voice under the control of the voice control section or the surround control section.

Also provided is a control method of an audio control device using a multi-screen. The method includes the following steps of: displaying a base axis and a treble axis for a sound of audio equipment on a touch screen in a multidimensional fashion; inputting a point selected by a user for audio control over the audio equipment on the touch screen; collectively calculating a bass value and a treble value corresponding to the point selected for audio control; and controlling a speaker based on the result of the step of collectively calculating the bass value and the treble value.

Also provided is a control method of an audio control device using a multi-screen. The method includes the following steps of: displaying X and Y-axes which perpendicularly intersect each other in a multidimensional fashion, the X and Y-axes being for volume control over surround speakers provided at different positions on a touch screen; inputting a point selected for control over the surround speakers on the touch screen; collectively calculating positional volume values of the surround speakers corresponding to the point selected for control over the surround speakers; and controlling the surround speakers based on the result of the step of collectively calculating the positional volume values of the surround speakers.

Also provided is a control method of an audio control device using a multi-screen. The method includes the following steps of: displaying an image of a radio channel, radio frequencies of the radio channel, a CD channel and tracks of the CD channel on a touch screen in a multidimensional fashion; inputting a point selected for channel adjustment on the touch screen; collectively calculating the radio frequencies of the radio channel or the tracks of the CD channel corresponding to the point selected for channel adjustment; and controlling the execution on the radio frequencies of the radio channel or the tracks of the CD channel based on a result of the step of collectively calculating the radio frequencies of the radio channel or the tracks of the CD channel.

Preferably, the displaying step may also display a volume axis on the touch screen.

Preferably, the calculating step may collectively calculate a volume value corresponding to the selected point together with the bass value and the treble value.

Preferably, the control method may further include the step of storing a specific radio frequency or a name of a specific broadcasting system to a radio frequency button.

Preferably, the point-inputting step may input the selected point via a button input.

Preferably, the point-inputting step may input the selected point by a voice.

Preferably, the point-inputting step may include recognizing and analyzing the point that is inputted by the voice.

Preferably, the control method may further include the step of outputting a voice via the speaker or the surround speakers.

### Advantageous Effects

According to the present invention as set forth above, the audio control device using a multi-screen and a control method thereof can improve user convenience by collectively conducting audio control in a multidimensional fashion instead of a one dimensional fashion.

### DESCRIPTION OF DRAWINGS

FIG. 1 is a block diagram of an audio control device using a multi-screen according to an embodiment of the present invention;

FIG. 2 is a flowchart showing a control method of the audio control device using a multi-screen according to an embodiment of the present invention;

FIG. 3 is a view showing a conversion between an audio control mode and a surround speaker control mode using the touch screen according to an embodiment of the present invention;

FIG. 4 is a view showing a conversion between the audio control mode and the surround speaker control mode using the button input according to an embodiment of the present invention;

FIG. 5 is a block diagram showing an audio control method according to an embodiment of the present invention;

FIG. 6 is a view showing the audio control multi-screen according to an embodiment of the present invention;

FIG. 7 is a view showing an operation of voice control using the touch screen according to an embodiment of the present invention;

FIG. 8 is a view showing an operation of voice control using the button input according to an embodiment of the present invention;

FIG. 9 and FIG. 10 are views showing an action of voice control using voice recognition according to an embodiment of the present invention;

FIG. 11 is a block diagram showing the process of controlling the surround speakers according to an embodiment of the present invention;

FIG. 12 is a view showing the multi-screen for controlling the surround speakers according to an embodiment of the present invention;

FIG. 13 is a view showing an operation of controlling the surround speakers using the touch screen according to an embodiment of the present invention;

FIG. 14 is a view showing an operation of controlling the surround speakers using the button input according to an embodiment of the present invention;

FIG. 15 is a block diagram showing the process of controlling a radio frequency or compact disc (CD) track according to an embodiment of the present invention;

FIG. 16 is a view showing an operation of selecting a CD track according to an embodiment of the present invention;

FIG. 17 is a view showing an operation of selecting a radio frequency according to an embodiment of the present invention;

FIG. 18 is a view showing an operation of allocating a frequency to a radio button according to an embodiment of the present invention;

FIG. 19 is a view showing an operation of designating a broadcasting system to a radio frequency button according to an embodiment of the present invention;

FIG. 20 is a view showing an operation of controlling surround speakers provided in a car using the touch screen according to another embodiment of the present invention;

FIG. 21 is a view showing an operation of controlling surround speakers provided in a car using a volume slider according to another embodiment of the present invention;

FIG. 22 is a view showing an operation of controlling surround speakers of a 2.1 channel audio system using a touch screen according to another embodiment of the present invention;

FIG. 23 is a view showing an operation of controlling surround speakers of a 5.1 channel audio system using a touch screen according to another embodiment of the present invention; and

FIG. 24 is a view showing an operation of controlling the surround speakers of a 5.1 channel audio system using a volume slider according to another embodiment of the present invention.

### MODE FOR INVENTION

Reference will now be made in detail to various embodiments of the present invention, examples of which are illustrated in the accompanying drawings and described below, so that a person having ordinary skill in the art to which the present invention relates can easily put the present invention into practice. It should be understood, however, that the present invention is intended to cover not only the exemplary embodiments, but also various different forms.

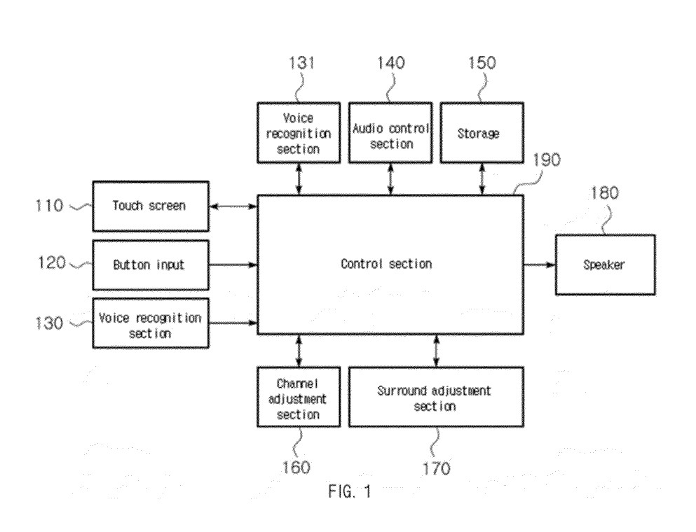

First, referring to FIG. 1, a description will be given of an audio control device using a multi-screen according to an embodiment of the present invention.

FIG. 1 is a block diagram of the audio control device using a multi-screen according to an embodiment of the present invention.

The audio control device 100 using a multi-screen includes a touch screen 110 into which a point selected by a user is inputted, a button input 120 or a voice input 130, a voice recognition section 131 which recognizes and analyzes a voice input, an audio control section 140 which controls sound of audio equipment, a storage 150 which stores therein values for the control over the audio equipment, a channel adjustment section 160 which controls a radio frequency or a compact disc (CD) track, a surround control section 170 which controls surround speakers, the speakers 180 which output the control sound or the like, and a control section 190 which controls the control sections 140, 160 and 170.

When the touch screen 110 is in an audio control mode, a bass axis and a treble axis for the sound of the audio equipment are multi-dimensionally displayed. In the case of a surround speaker control mode, a vehicle image in which surround speakers (not shown) are located at different positions is multi-dimensionally displayed. In the case of a channel adjustment mode, images of a radio channel, a radio frequency of that channel, a CD channel and a CD track of that channel are displayed.

Referring to FIG. 8 which will be described later, the button input 120 is a four or eight-directional button which is provided separately from the touch screen 110. In addition, it is possible to move a sound-controlling spot (point a′) into a selected point (point b′) by controlling buttons.

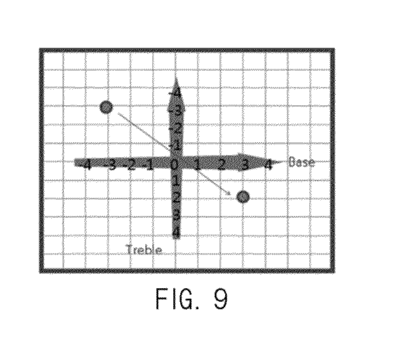

The voice input 130 receives a voice about information that corresponds to the point selected by the user. Referring to FIG. 9, the user can move a sound-controlling spot (point c) into the selected point (point d) by inputting information such as “sound 3, 2” corresponding to the selected point into the voice input 130.

The voice recognition section 131 converts the voice, which is inputted into the voice input 130 as the selected point, into a signal that can be recognized by the audio control section 140, the surround control section 170 or the channel adjustment section 160.

The audio control section 140 then collectively calculates the bass value and the treble value corresponding to the sound-controlling selected point that is inputted on the touch screen 110.

Specifically, when the selected point with which the audio control device 100 controls the sound is inputted via the touch screen 110, the button input 120 or the voice input 130, coordinate values on the bass axis and the treble axis corresponding to the input of the selected point are calculated.

The storage 150 stores each of the control values in a corresponding area in the multi-screen displayed on the touch screen 110.

Specifically, the bass and treble values corresponding to the coordinate values depending on the areas and volume values of the surround speakers 180 are stored together with the radio frequency or the CD track.

The channel adjustment section 160 calculates the frequency of the radio channel or a track value of the CD channel that corresponds to the selected point that is inputted on the touch screen 110, the selected point being for the adjustment of the radio or CD channel of the audio equipment.

That is, when the selected point for the channel adjustment of the radio channel and the frequency of the radio channel or the CD channel and the CD track of the CD channel which is displayed on the touch screen 110 is inputted, the channel adjustment section 160 calculates a radio frequency value on the touch screen 110 corresponding to the selected point or the coordinate values of the CD track on the touch screen 110.

The surround control section 170 collectively calculates positional volume values of the surround speakers 180 that correspond to the selected point for the control over the surround speakers 180 that is inputted on the touch screen 110.

That is, when the selected point for the control over the surround speakers 180 which are provided at different positions on the X and Y-axes disposed on the touch screen 110 is inputted, the surround control section 170 calculates coordinate values of the area on the touch screen 110 where the selected point is located.

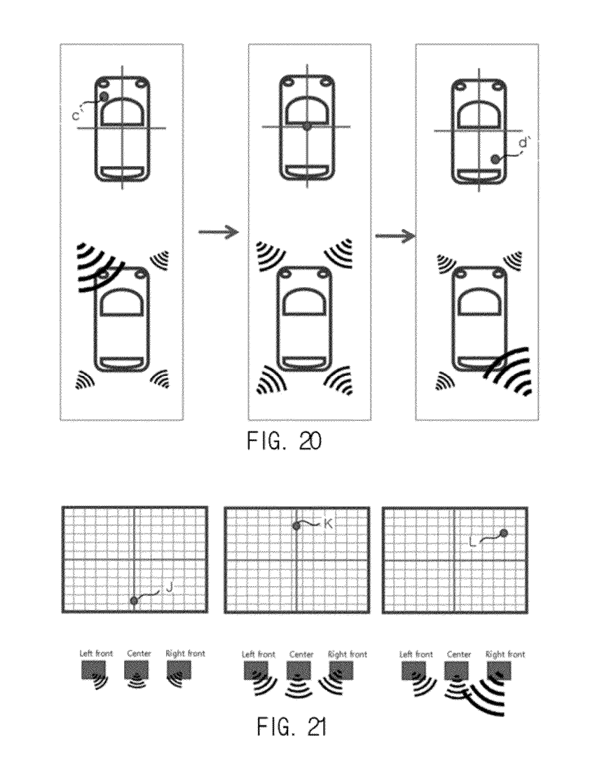

For instance, as shown in FIG. 14 and FIG. 20, upon movement from a surround speaker controlling spot (point c or c′) on the touch screen 110 to a selected point (point d or d′) on an image of a car where the surround speakers 180 to be controlled are located, the volume of the speaker 180 which is located in the rear or rear right of the car is increased.

In addition, as shown in FIG. 21, in the case of a 2.1 channel audio system, upon movement from a point (point J) where the volumes of the left, center and right speakers 180 are low to a selected point (point K) where the surround speakers 180 to be controlled are located, the volumes of the left, center and right speakers 180 are increased. Upon movement to another selected point (point L), the volume of the right speaker 180 is increased.

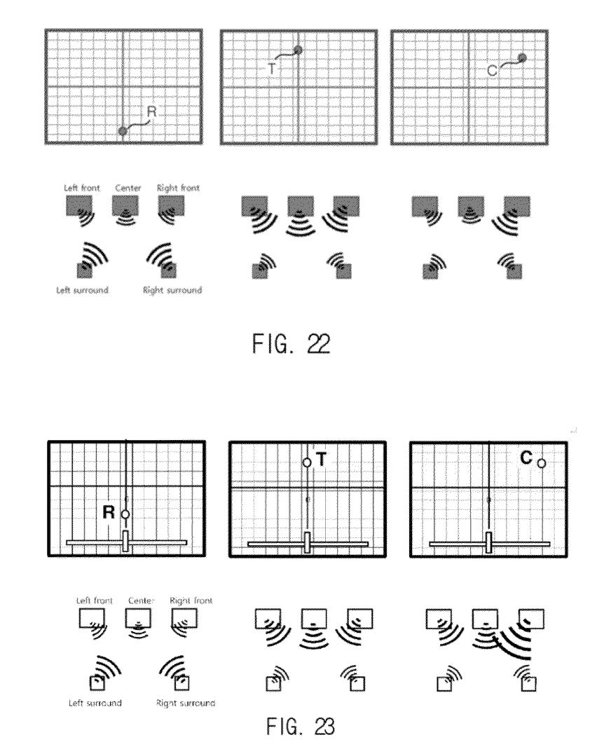

In addition, as shown in FIG. 22, in the case of 5.1 channel audio system, upon movement from a surround speaker controlling spot (point R) on the touch screen 110 to a selected point (point T) where the surround speakers 180 to be controlled are located, the volumes of the front left, center and right speakers 180 are increased. Upon movement to another selected point (point C), the volume of the front right speaker 180 is increased.

The speakers 180 output the output sound of the audio equipment under the control of the control section 190, based on the bass and treble values of the sound, volume values, a radio channel or the like corresponding to the point selected by the user that is inputted from the touch screen 110 or the like.

The control section 190 controls the sound of the speakers of the audio equipment or the volumes of the surround speaker based on the value calculated by the audio control section 140 and the surround control section 170, and based on the value calculated by the channel control section 180, executes the radio frequency or CD track corresponding to the calculated value.

Specifically, the control section 190 maps the coordinate values calculated by the audio control section 140 with the bass and treble values stored in the storage 150, and controls the sound of the speakers 180 with reference to the mapped bass and treble values. Here, a variety of components to be controlled can be applied to the two-dimensional X and Y-axes, i.e. the bass and treble axes.

In addition, the control section 190 maps the coordinate values calculated by the surround control section 170 with the volume values of the surround speakers 180 stored in the storage 150, and controls the volumes of the surround speaker depending on the mapped volume values.

In addition, the control section 190 maps the coordinate values calculated by the channel adjustment section 160 with the radio channel and the frequency of the radio channel or the CD channel and the CD track of the CD channel stored in the storage 150, and controls the execution on the mapped radio frequency or CD track.

According to the audio control device 100 using a multi-screen that has the above-described configuration, there is an effect that can improve user convenience by collectively conducting audio control in a multidimensional fashion instead of a one-dimensional fashion.

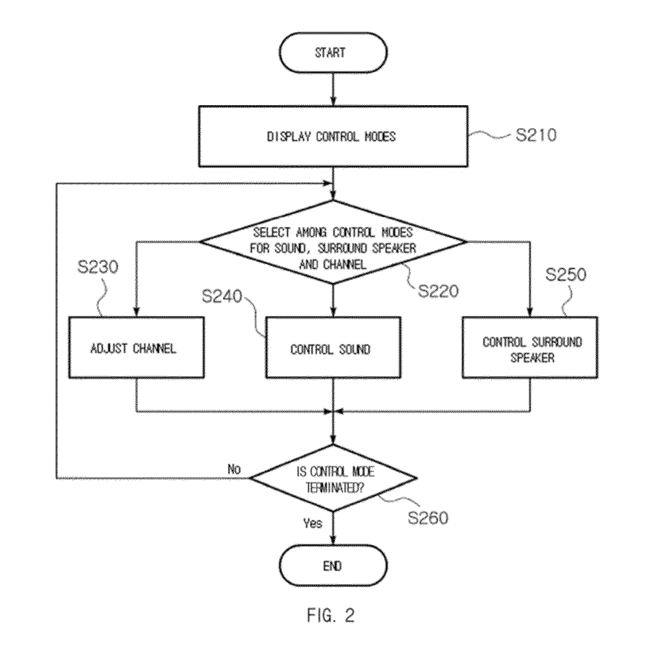

Hereinafter, a control method of an audio control device using a multi-screen according to the present invention will be described with reference to FIG. 2 to FIG. 17.

FIG. 2 is a flowchart showing the control method of an audio control device using a multi-screen according to an embodiment of the present invention.

As shown in FIG. 2, the control method of the audio control device using a multi-screen includes the step of displaying control modes for the adjustment of sound, surround speakers or channels on a multi-screen (S210), the step of selecting one control mode from among the control modes for the adjustment of sound, surround speakers or channels (S220), the steps of controlling the sound or the like in the selected control mode (S230, S240, S250), and the step of determining whether or not the selected control mode is terminated (S260).

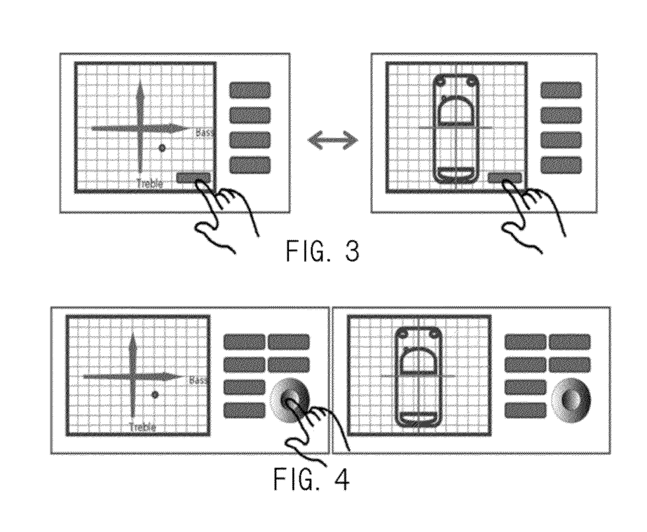

Describing in more detail, at S210, the control modes are displayed. Afterwards, at S220, the user selects one control mode from among the control modes for the adjustment of sound, surround speakers or channels. For instance, as shown in FIG. 3 and FIG. 4, conversion can be made between the sound control mode and the surround speaker control mode using a screen conversion button which is provided on the touch screen 110 or in the button input 120.

After that, audio-related control is executed in the control mode that is selected by the user. In the case of the sound control over the output sound of the audio equipment, the bass and the treble are displayed on the multi-screen and are collectively controlled at S230. In the case of the volume control over the surround speakers 180, an image of a car is displayed on the multi-screen and the volumes of the speakers 180 are collectively controlled at S240. In the case of the channel adjustment, images of the radio channel and the CD channel are displayed and the channels are collectively adjusted at S250.

Afterwards, at S260, the control section 190 determines whether or not the control mode for the audio-related control is terminated. Specifically, when the adjustment for the control mode is not terminated, the step S220 of selecting one control mode from among the control modes for the adjustment of sound, surround speakers or channels is repeated.

In addition, when the adjustment for the control mode is terminated, the control section 190 finishes the adjustment for the audio-related control.

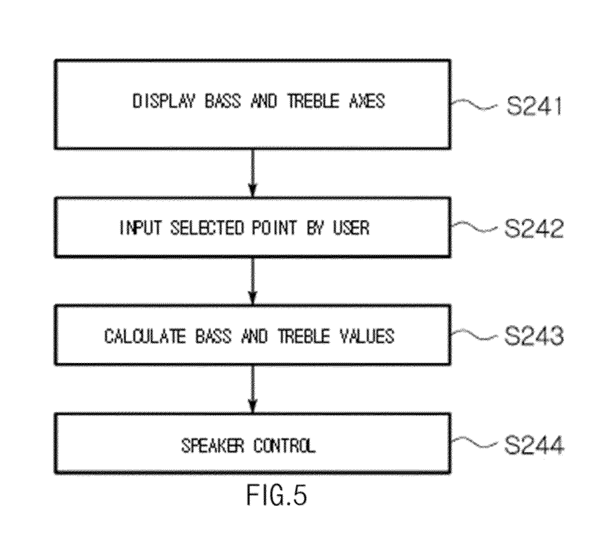

With reference to FIG. 5 to FIG. 10, the step of controlling the sound of the speakers of the audio equipment will be described in more details

FIG. 5 is a block diagram showing the process of controlling the sound of the speakers of the audio equipment according to an embodiment of the present invention.

First, at S241, the bass and treble axes along which the sound control over the output sound of the speakers of the audio equipment is conducted are displayed on the touch screen 110 in a multi-screen fashion.

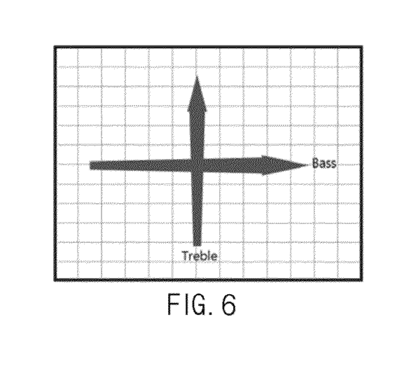

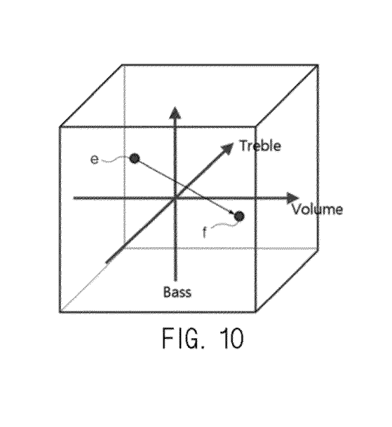

That is, as shown in FIG. 6, in the sound control mode, the two axes, i.e. the bass axis and the treble axis, that perpendicularly intersect each other are provided on the touch screen 110 in a two-dimension fashion. In addition, as shown in FIG. 10, the bass axis, the treble axis and the volume axis can be displayed on the touch screen 110 in a three-dimensional fashion. Here, preferably, the two-dimensional X and Y-axes, including the base axis and the treble axis, or the three-dimensional X, Y and Z-axes, including the base axis, the treble axis and the volume axis, can employ a variety of components to be controlled as required in addition to the base, treble and volume elements.

In sequence, at S242, the user inputs a point for the sound control over the output sound of the speakers of the audio equipment on the touch screen 110 by selecting the point.

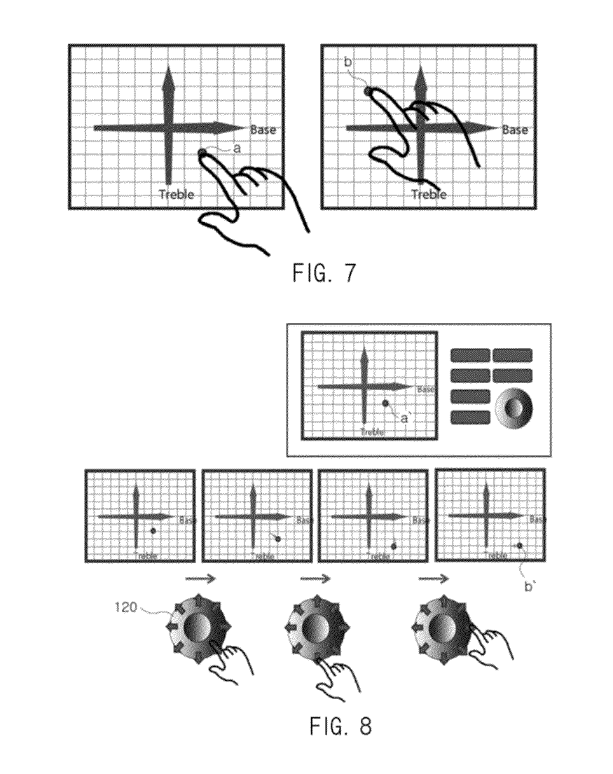

Specifically, as shown in FIG. 7, the user can directly move a sound-controlling spot (point a) that is located on the bass and treble axes on the touch screen 110 to a selected point (point b) on the bass and treble axes to be controlled.

In addition, as shown in FIG. 8, the user can move a sound-controlling spot (point a′) on the touch screen to a selected point (point b′) on the bass and treble axes to be controlled using the button input 120.

In addition, as shown in FIG. 9, it is possible to move a sound-controlling spot (point c) on the touch screen 110 to a selected point (point d) on the bass and treble axes to be controlled using the voice input 130.

Specifically, the user can say “sound 3, 2” or, individually, “bass 3, treble 2.” When the user says to the voice input 130 in this fashion, the voice recognition section 131 recognizes what the user says, and the control section 190 moves the sound-controlling spot to the selected point.

In particular, as shown in FIG. 10, when the bass axis, the treble axis and the volume axis are displayed on the touch screen 110 in a three-dimensional fashion, it is possible to input a selected point (point f) using the voice input 130 by a voice.

Specifically, the user can say “sound 3, 2, 1” or, individually, “bass 3, treble 2, volume 3.”

Afterwards, at S243, the audio control section 140 calculates the coordinate values of the bass and the treble on the touch screen 110 corresponding to the selected point for the control over the sound that is inputted on the touch screen 110.

As shown in FIG. 7 to FIG. 10, when inputting a selected point (point b, b′, d or f) on the bass and treble axes or the bass, treble and volume axes that corresponds to the sound to be controlled from a sound-controlling spot (point a, a′, c or e) that is located on the touch screen, the audio control section 140 calculates the coordinate values on the touch screen 110 that correspond to the selected point.

Finally, at S244, the control section 190 maps the coordinate values of the selected point calculated from the audio control section 140 with the bass and treble values or the bass, treble and volume values stored in the storage 150, and conducts audio control over the output sound of the speakers 180 based on the bass and treble values or the bass, treble and volume values corresponding to the coordinate values.

As shown in FIG. 6, the control section 190 conducts the audio control over the output sound of the speakers of the audio equipment depending on the bass and treble values corresponding to the coordinate values on the bass and treble axes that correspond to the inputted selected point (point d).

Afterwards, with reference to FIG. 11 to FIG. 14, the step of controlling the volumes of the surround speakers will be described.

FIG. 11 is a block diagram showing the process of controlling the surround speakers according to an embodiment of the present invention.

First, at S251, an image of a car in which surround speakers are provided at different positions on the touch screen is displayed in a multidimensional fashion.

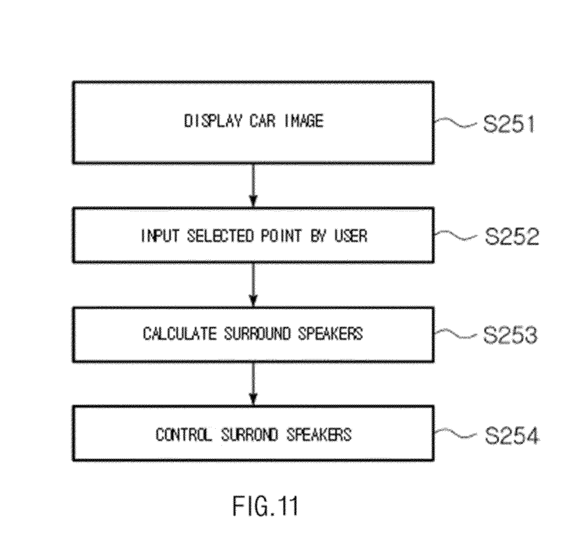

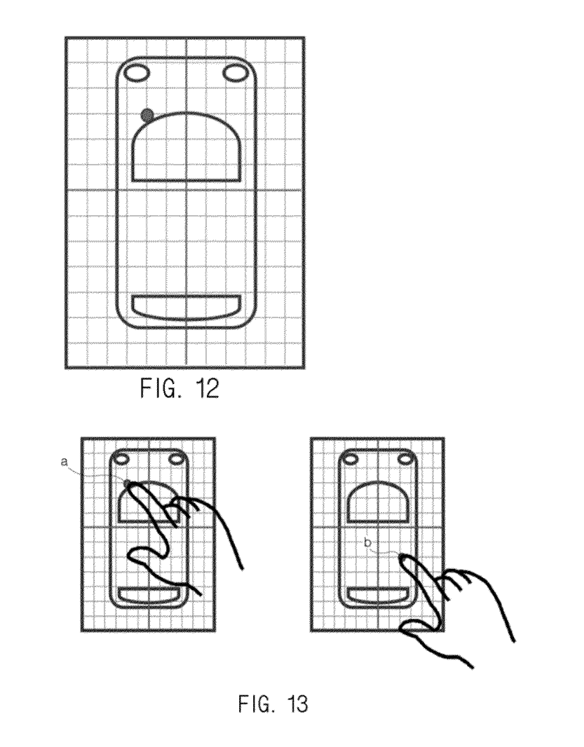

That is, as shown in FIG. 12, in the surround speaker control mode, X and Y-axes that perpendicularly intersect each other are displayed on the touch screen 110 in a two-dimensional fashion, and the image of the car including surround speakers (not shown) which are provided at different positions on the X and Y axes is displayed.

Afterwards, at S252, the user inputs a point selected by the user for the control over the volume of the output sound of the surround speakers is inputted on the touch screen 110.

Specifically, as shown in FIG. 13, the user moves a surround speaker-controlling spot (point a) to a selected point (point b) on the touch screen 110. The surround speaker-controlling spot (point a) is located on the image of the car on the X and Y-axes, the selected point (point b) is located on the image of the car where the surround speakers to be controlled are located. Here, the volume of the speakers can be controlled using a volume slide at the bottom of the touch screen.

In addition, as shown in FIG. 14, it is possible to input a selected point (point d) on the image of the car where the surround speakers to be controlled are located from a surround speaker-controlling spot (point c) on the touch screen 110 using the button input 120.

In addition, it is possible to input the selected point using the voice input 130 by a voice. That is, the user can input coordinate values 2 and 5 on the X and Y-axes by a voice by saying “speaker 2, 5.”

Afterwards, at S253, the surround control section 170 collectively calculates coordinate values on the touch screen 110 that correspond to the selected point for the control over the surround speakers that is inputted on the touch screen 110.

Specifically, as shown in FIG. 13 and FIG. 14, this step calculates the coordinate values on the touch screen 110 corresponding to the selected point on the X and Y-axes corresponding to the volumes of the surround speakers to be controlled from the surround speaker-controlling spot (point a or c) located on the touch screen 110.

Finally, the control section 190 maps the coordinate values of the selected point calculated by the surround control section 170 with the volume values of the surround speakers 180 stored in the storage 150, and controls the volumes of the output sound of the speakers 180 based on the mapped volume values.

Specifically, as shown in FIGS. 20 and 21, upon moving from a surround speaker-controlling spot (point c′) on the touch screen 110 to a selected point (point d′) on the image of the car where the surround speakers 180 to be controlled are located, the volume of the speaker 180 located at the rear right is increased. In addition, it is possible to control the volumes of all of the speakers using the volume slider at the bottom of the touch screen 110, i.e. it is possible to increase or decrease the volumes.

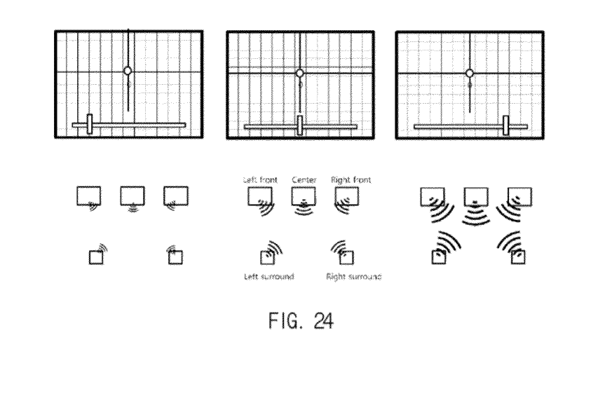

In addition, as shown in FIG. 22 and FIG. 24, in the case of a 2.1 or 5.1 channel audio equipment, upon moving from a surround speaker-controlling spot (point J or R) on the touch screen 110 to a selected point (point K or T) where the surround speakers 180 to be controlled are located, the volumes of the left, center and right speakers 180 shown in FIG. 22 or the front left, center and right speakers 180 shown in FIG. 23 are increased. In addition, it is possible to control, e.g. increase or decrease, the volumes of all of the speakers at one time using the volume slider at the bottom of the touch screen shown in FIG. 24.

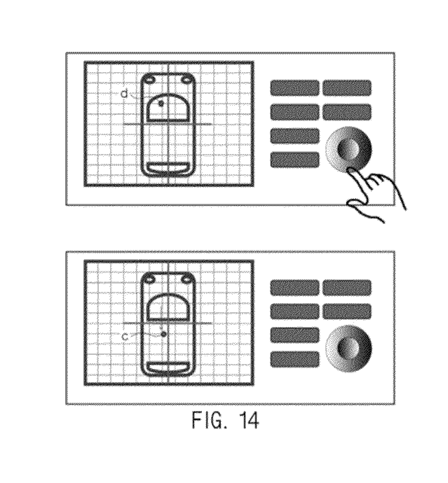

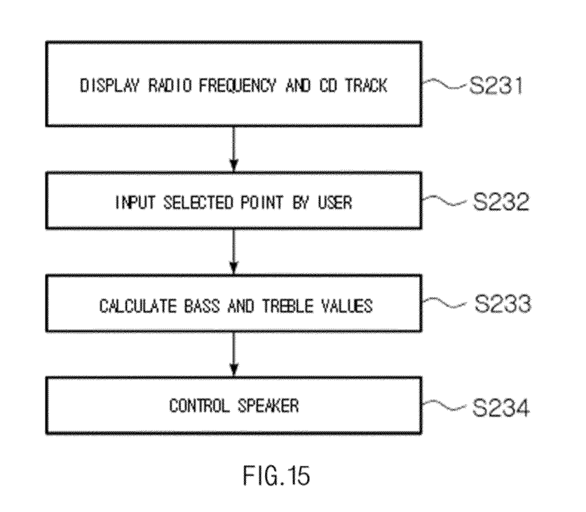

Afterwards, with reference to FIG. 15 to FIG. 19, the process of controlling the frequency or CD track about the radio channel of the audio equipment will be described.

FIG. 15 is a block diagram showing the process of controlling a radio frequency or CD track according to an embodiment of the present invention.

First, at S231, a radio channel and a radio frequency of the radio channel and a CD channel and a track of the CD channel are displayed on the touch screen 110 in a multidimensional fashion.

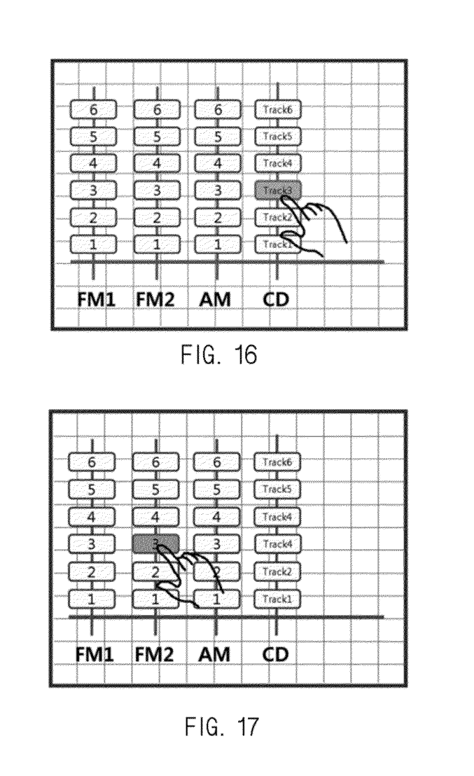

Specifically, as shown in FIG. 16, in the channel adjustment mode, a plurality of radio channels and a CD channel are located on the X-axes. A plurality of radio frequency buttons are located on Y-axes that perpendicularly intersect the radio channels, and a plurality of CD track buttons are displayed on the Y-axes that perpendicularly intersect the radio channels.

Afterwards, at S232, a point selected by the user for selecting a radio frequency or a CD track is inputted on the touch screen 110.

As shown in FIG. 16 and FIG. 17, a selected point on the touch screen 110 corresponding to one radio frequency button (button 3 of FM2) or one CD track button (Track 3) from among the radio frequency buttons or CD track buttons displayed on the touch screen 110 is inputted.

After that, at S233, the channel adjustment section 160 collectively calculates the radio frequency or CD track corresponding to the point that is selected for channel adjustment.

Specifically, as shown in FIG. 16 and FIG. 17, when the selected point corresponding to the radio frequency button (button 3 of FM2) or the CD track button (Track 3) from among the radio frequency buttons or CD track buttons located on the touch screen 110, the channel adjustment section 160 calculates coordinate values on the touch screen 110 corresponding to the selected point.

Finally, at S234, the control section 190 maps the coordinate values of the selected point calculated by the channel adjustment section 160 with the button that corresponds to the radio channel and the frequency of the radio channel or the CD channel and the CD track of the CD channel stored in the storage 150, and controls the execution on the mapped radio frequency or CD track.

In addition, when a broadcasting program of an allocated frequency is selected in the case where a corresponding button is selected by allocating a frequency to each of the radio frequency buttons or when a radio frequency button corresponding to each name of broadcasting systems is selected by allocating each name of broadcasting systems to a corresponding radio frequency button, the step of selecting a broadcast program of the corresponding broadcasting system can also be included.

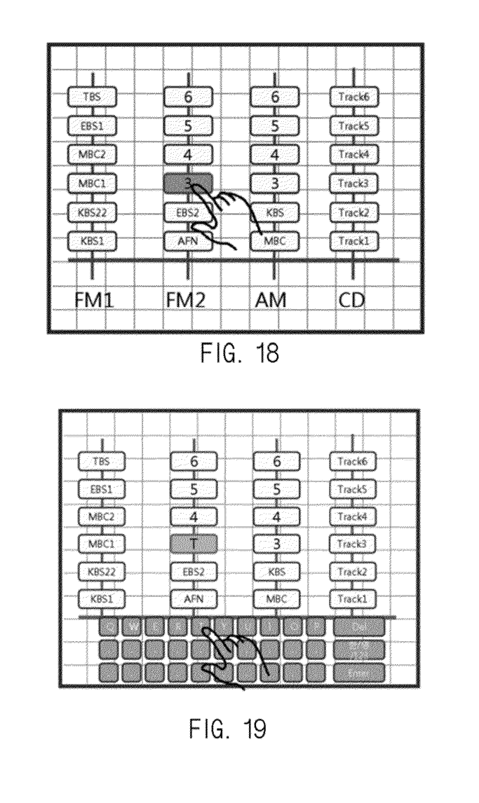

For instance, in the state in which the frequency is set to FM 102.3 as shown in FIG. 18, when the third radio frequency button of FM2 is pressed for about 3 seconds, this frequency is allocated to that button.

In addition, as shown in FIG. 19, when the third radio frequency button of one radio channel, or FM2, is pressed for about 2 seconds, an English input keyboard (Qwerty keyboard) or a Hangul (Korean alphabet) input keyboard appears, whereby the user can input an intended name. Accordingly, the user can designate the name of a broadcasting system to each of the radio frequency buttons on the multi-screen.

According to the control method of the audio control device using a multi-screen as set forth above, it is possible to improve user convenience by collectively conducting the audio control in a multidimensional fashion instead of a one-dimensional fashion.

While the present invention has been described in detail in relation to the certain embodiment, the present invention is not limited to this specific structure. Rather, modifications and changes can be made without departing from the principle of the present invention. It is intended that all changes or modifications clearly fall within the scope of the Claims of the present invention.

1. An audio control device using a multi-screen, comprising:
a touch screen on which a bass axis and a treble axis for a sound of audio equipment are displayed in a multidimensional fashion, and on which a point selected by a user for audio control is inputted;
an audio control section which collectively calculates a bass value and a treble value corresponding to the point selected for audio control; and
a control section which controls a speaker based on a result calculated by the audio control section.

2. An audio control device using a multi-screen, comprising:
a touch screen on which X and Y-axes are displayed in a multidimensional fashion, and a point selected by a user for volume, control over surround speakers which are provided at different positions is inputted;
a surround control section which collectively calculates volume values of the surround, speakers depending on the positions that correspond to the point selected for volume control over the surround speakers; and
a control section which controls the surround speakers based on a result calculated by the surround, control section.

3. An audio control device using a multi-screen, comprising:
a touch screen which displays an image of a radio channel, radio frequencies of the radio channel, a compact disc channel and tracks of the compact disc channel in a multidimensional fashion, and on which a point selected by a user for channel adjustment is inputted;
a channel adjustment section which calculates the radio frequencies of the radio channel or the tracks of the compact disc channel corresponding to the point selected for channel adjustment; and
a control section which collectively controls an execution on the radio frequencies of the radio channel or the tracks of the compact disc channel based on as result calculated by the channel adjustment section.

4. The audio control device according to claim 1, wherein the touch screen further comprises a volume axis, and the audio control section collectively calculates, together with the bass value and the treble value, as volume value based on the result.

5. The audio control device according to claim 3, wherein the channel adjustment section stores a specific radio frequency or a name of a specific broadcasting system to a radio frequency button.

6. The audio control device according to claim 1, further comprising a button input into which the point selected by the user is inputted.

7. The audio control device according to claim 1, further comprising a voice input into which the point selected by the user is inputted by a voice.

8. The audio control device according to claim 7, further comprising a voice recognition section which analyzes the voice that is inputted via the voice input.

9. The audio control device according to any one of claim 1, further comprising a storage which stores a control value for a multidimensional axis corresponding to the selected point.

10. The audio control device according to claim 1, further comprising a voice output which outputs a voice under control of the voice control section or the surround control section.

11-20. (canceled)

21. The audio control device according to claim 2, further comprising a button input into which the point selected by the user is inputted.

22. The audio control device according to claim 2, further comprising a voice input into which the point selected by the user is inputted by a voice.

23. The audio control device according to any one of claim 3, further comprising a storage which stores a control value for a multidimensional axis corresponding to the selected point.

24. The audio control device according to claim 2, further comprising a voice output which outputs a voice under control of the voice control section or the surround control section.
